(19) United States
(12) Patent Application Publication
(10) Pub. No.: US 2026/0061633 A1
(43) Pub. Date: Mar. 5, 2026

(54) DEVICE FOR GRIPPING LAYERS OF PRODUCTS

(71) Applicant: FIVES SYLEPS, Lorient (FR)

(72) Inventors: Vincent POUPARD, Lorient (FR); Aymeric FRESNEAU, Lorient (FR)

(21) Appl. No.: 18/854,356

(22) PCT Filed: Apr. 4, 2023
(86) PCT No.: PCT/EP2023/058890

§ 371 Date: Oct. 4, 2024

(30) Foreign Application Priority Data
Apr. 5, 2022 (FR) 2203119

(51) Int. Cl. B25J 15/06; B25J 15/02; B65G 61/00

(52) U.S. Cl. CPC B25J 15/0616; B25J 15/0253; B65G 61/00

(57) ABSTRACT

A gripping device, suitable for grasping a layer of products, including a horizontal suction plate connected to a pumping device and having vacuum openings and being arranged to come into contact with a layer of products by displacing the gripping device using a robot, and a flexible lateral skirt forming a band surrounding the suction plate, wherein the skirt is configured to move from a rest position in which it is at a distance from the layer of products into a working position in which it is in contact with the layer of products and the suction plate, the latter being capable of moving vertically relative to the skirt to adapt the vacuum volume to the height of the layer of products to be gripped by the gripper.

### TECHNICAL FIELD OF THE INVENTION

The invention belongs to the technical field of apparatuses and systems applicable to the field of logistics.

In particular, the invention is directed to a gripping device that can be mounted to a palletising or depalletising robot for gripping layers of products.

### TECHNOLOGICAL BACKGROUND OF THE INVENTION

Palletising or depalletising systems exist in this field, implementing a robot to deposit or remove layers of products, especially by clamping or gripping from below or by suction.

Existing solutions are generally adapted to certain products only and lack efficiency. In particular, some solutions have a movable gripper plate in a vacuum chamber, however the volume of the chamber is not adapted to the height of objects, making the vacuum ineffective. Others systematically require mechanical clamping on the sides, which is not suitable for fragile objects.

Some solutions use a system to support gripped objects from below, but these systems are often of large overall size.

The purpose of the present invention is to provide a gripping device suitable for mounting to a palletising robot and enabling at least part of the above-mentioned problems to be solved.

### SUMMARY OF THE INVENTION

To this end, the invention relates to a gripping device to be mounted to a palletising or depalletising robot for gripping a set of products arranged in the form of at least one layer on a container, said gripping device comprising a chassis to which are mounted:
a suction plate comprising side faces forming bearing surfaces and a lower face which forms a substantially horizontal plane with respect to the ground when the gripping device is mounted to the robot, said suction plate being connected to a first pumping device and having vacuum openings, and being arranged so that its lower face comes into contact with a layer of products by a displacement of the gripping device, and
a side skirt of a flexible material forming a strip surrounding said side faces of the suction plate,

According to the invention, the skirt is configured to move from a rest position in which it is at a distance from the layer(s) of products to a working position in which it is in contact with the layer(s) of products and the bearing surfaces of the suction plate and in which it forms, with the plane (P), a closed vacuum volume above and to the sides of the layer(s) of products, the suction plate being vertically movable with respect to the skirt to adapt the vacuum volume to the height of the layer(s) of products to be gripped by the gripper.

Adapting the vacuum volume to the objects reduces leakage and maximises the vacuum effect and allows better holding of the objects.

Vacuum holding is suitable for all types of object, especially the most fragile which cannot be held by mechanical clamping, such as secondary packaging for dairy products.

Optionally, the vacuum volume can be adapted to the nature of the products.

The robot can be poly-articulated, Cartesian or any other system suitable for palletising or depalletising that can support the gripper according to the invention.

The products may be of different types, for example cardboard boxes, dairy products or any other product from the food industry likely to be transported on a pallet.

Advantageously, the suction plate can comprise side openings on its contour to adhere the side skirt to its bearing faces by suction in the working position. This allows better sealing of the vacuum volume.

Advantageously, the gripping device also comprises a clamping device that can be activated to come into contact with and/or clamp the layer(s) of products. This ensures or improves holding of products, especially rigid products.

Depending on the nature of the products, the clamping device can clamp the products when they are rigid or just in contact to promote holding by the vacuum.

According to one exemplary embodiment, the clamping device comprises four telescopic bars forming a rectangle whose surface area decreases when the clamping device is activated to come into contact with the layer of products. This helps to delimit the vacuum space and increases product holding efficiency.

According to one exemplary embodiment, the skirt comprises four rectangular webs, each being disposed on one side of the rectangle defined by the telescopic bars and having a length similar to the maximum length of the telescopic bar disposed on the same side of the rectangle and having a lower side partially attached thereto.

This facilitates maintenance and increases the life time of the skirt, as it is more suitable for changing sizes of layers of products.

Advantageously, an accumulation device can be arranged between each pair of adjacent telescopic bars, said accumulation device being configured to receive an excess part of each of the two webs attached to said pair of telescopic bars when the clamping device is activated to come into contact with the layer(s) of products.

The accumulation device can have a height at least similar to the height of the webs. This provides proper sealing, which increases vacuum effectiveness. In addition, by preventing folding or creasing of the excess parts of the webs, the life time of the skirt is increased.

Advantageously, the gripping device can also include a tray for supporting the layer(s) of products, horizontally movable between a support position in which it is located under the layer(s) of products and a retracted position in which it is away from the products. The products are, for example, held by the vacuum and secured from below by the tray to prevent one or several products from falling out.

Advantageously, the support tray can be formed by a plurality of panels hinged to one another and capable of being deployed under the products in the support position and of being retracted into the retracted position. This arrangement reduces the dead space and the size of the system, consequently the gripper is more compact.

Advantageously, the tray can be formed from two identical parts, each arranged on one side of the base of the chassis. This arrangement in two parts further reduces the overall size of the gripping device.

Advantageously, the suction plate can also comprise suction openings connected to a second pumping device and configured to suck up products when the suction plate is in the contact position with the layer(s) of products.

The suction openings distinct from the vacuum openings can, for example, be connected to a vacuum pump capable of providing a high flow rate and enabling powerful suction of the products from above.

The suction openings may, for example, open into individual suction cups or foam plates arranged at the lower end of the suction plate.

Advantageously, the gripping device can include at least one detector for detecting contact between the suction plate and the products.

The invention is also directed to a palletising or depalletising system comprising a robot provided with a gripping device as described above.

### BRIEF DESCRIPTION OF THE FIGURES

Further features and advantages of the invention will become apparent from the description below in connection with the appended drawings, given by way of non-limiting examples of the invention, in which:

FIG. 1 is an overall view of an example of a gripper according to the invention.

FIG. 2 is an exploded view of the gripper of FIG. 1.

FIG. 3 is a bottom view the gripper of FIG. 1.

FIG. 4 is a perspective bottom view showing a support plate in the retracted position.

FIG. 5 is a bottom perspective view showing an example of a two-part support tray in the open position.

FIG. 6 is a perspective bottom view showing an accumulation device according to one exemplary embodiment of the invention.

Unless otherwise specified, a same element appearing in different figures has a single reference.

### DETAILED DESCRIPTION

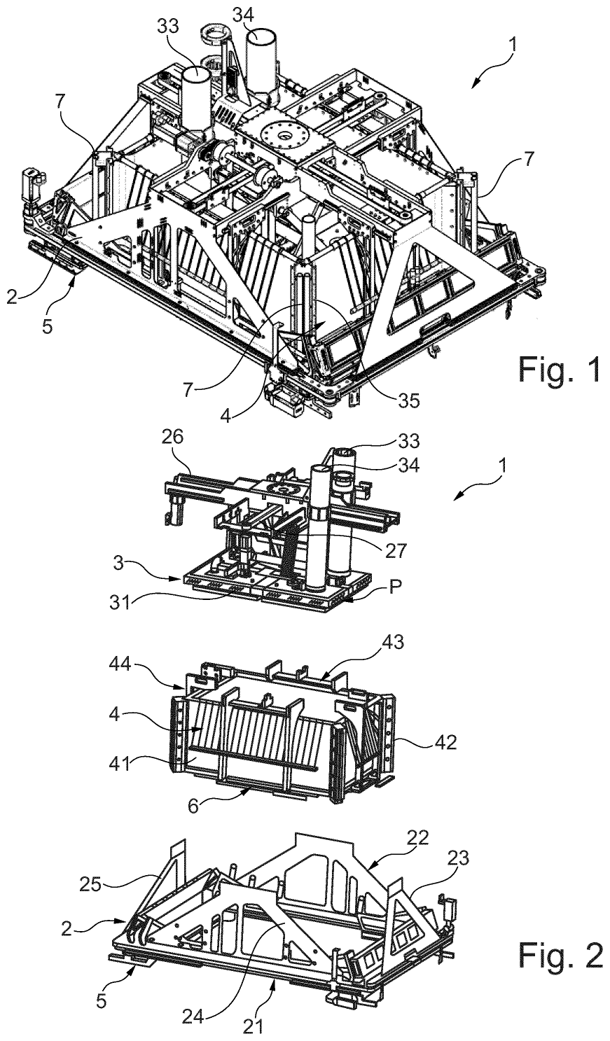

FIG. 1 shows a schematic representation of one exemplary embodiment of a gripper 1 according to the invention. FIG. 2 is an exploded view of the gripper 1 of FIG. 1.

The gripper 1 can be mounted to a polyarticulated robot or a Cartesian-type robot.

According to the exemplary embodiment illustrated, the gripper 1 comprises a chassis 2 with a rectangular base 21 and supports 22, 23, 24, 25 rising from the base 21. A system of crossed bridges 26, 27 can be attached to the upper end of the supports 22, 23, 24, 25. A suction plate 3 is connected to said system of bridges by a mechanism allowing vertical displacement of the suction plate relative to the chassis. Such a mechanism is known per se and will therefore not be detailed here.

In the exemplary embodiment, the suction plate 3 is connected to two turbine pumps via tubes 33, 34 and comprises openings 30 downwards and side openings 31.

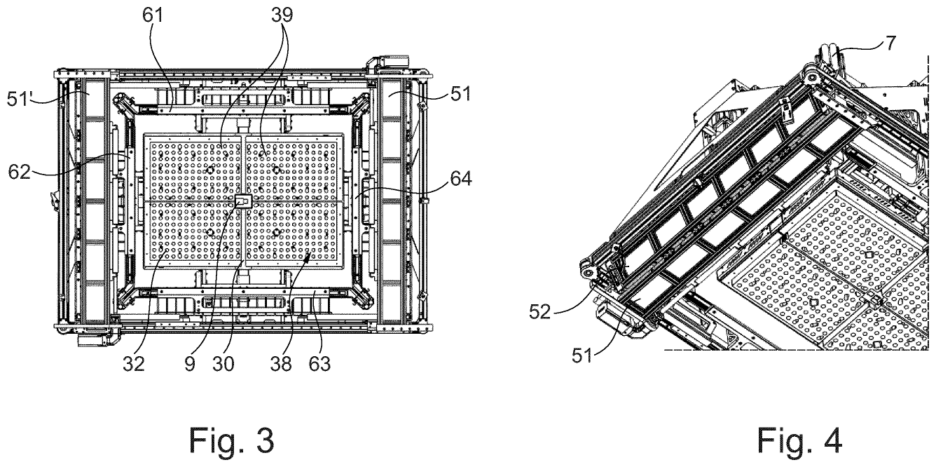

Advantageously, the suction plate 3 can also comprise suction openings 32, visible in FIG. 3. These suction openings are connected to a vacuum pump 35 so that the products can be sucked directly from above when the suction plate is in contact with the layer of products and the vacuum is actuated. This is especially useful for products with a regular upper face that can be sucked up.

In the exemplary embodiment illustrated, the lower face 38 comprises foam plates 39 into which the suction openings 32 open, through which the objects can be sucked.

According to another exemplary embodiment, not illustrated, the suction openings open into individual suction cups.

As shown in FIG. 2, a side skirt 4 of flexible material forms a strip around the side faces of the suction plate 3.

According to the exemplary embodiment illustrated in FIGS. 2 and 6, the skirt 4 comprises four rectangular webs 41, 42, 43, 44. The lower side of each web is partly attached to a telescopic bar 61, 62, 63, 64 of a clamping device 6 arranged in the base 21 of the chassis. Attachment is made on the part of the telescopic bar that remains fixed. The web is not attached to the slide 71, 72.

As represented in FIG. 3, the clamping device 6 is in a configuration where the telescopic bars 61, 62, 63, 64 have their maximum lengths.

In the exemplary embodiment shown in FIGS. 1 and 3, the upper side and the other sides are also attached by known means so that each web retains the shape of a rectangle.

Furthermore, as is especially visible in FIGS. 1 and 6, an accumulation device 7 is arranged between each pair of adjacent telescopic bars 61, 62. The accumulation device 7 is configured to receive the excess part of each of the two webs 41, 42 attached to the pair of telescopic bars 61, 62 when the clamping device is activated to come into contact with the layer(s) of products.

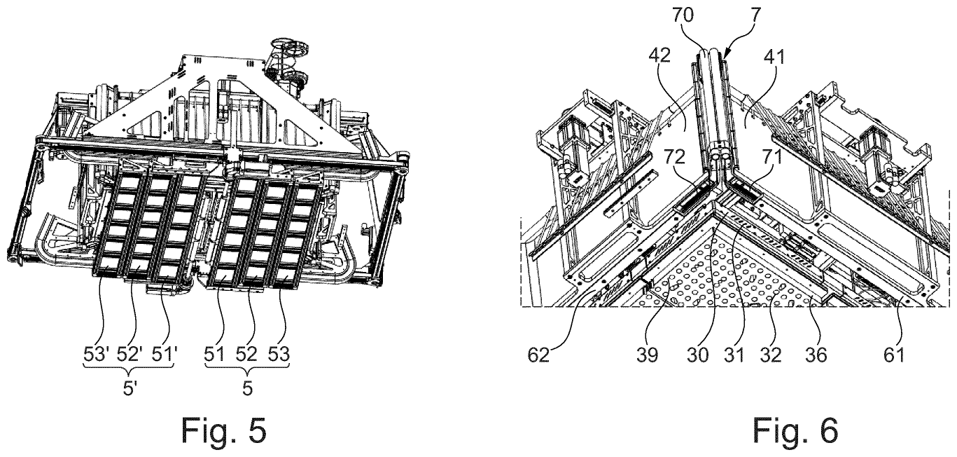

FIGS. 4 and 5 show an optional tray 5, 5′ for supporting the layer(s) of products in the support position in which it is deployed beneath the layer(s) of products.

According to the example shown, the support tray is formed of two parts each comprising a plurality of panels 51, 52, 53, 51′, 52′, 53′hinged to one another and capable of being deployed under the products in the support position and of being retracted into the retracted position as in FIG. 4.

To load one or more layer(s) of products using the gripping device 1 according to the invention, the following steps are carried out by the palletising/depalletising system comprising the device 1:
the robot carrying the gripping device 1, displaces the same towards the pallet on which the products are loaded,
with the suction plate 3 in a low position at the base 21 of the chassis, the device 1 is displaced until contact is made between the lower face of the plate 3 and the upper face of the products; a 3D camera 9 can be used to centre the gripper during this descent. The contact can be detected by infrared detectors located in the lower part of the chassis and/or a movement detector in the upper part of the chassis.
the robot continues to descend, which causes relative displacement of the suction plate 3 to the skirt, this displacement being a predetermined vertical distance relative to the thickness of the layer(s) of products to be gripped.
depending on the nature of products, the clamping device 6 can be activated to come into contact with the products only or to exert a clamping force on the products. Upon displacing the telescopic bars 61, 62, 63, 64 into contact with the products, the skirt webs are also displaced until contact is made between the skirt and the side surfaces 30 of the plate 3, as well as with the products. Upon displacing the webs forming the telescopic skirt 4 into contact with the products, the excess part of each web 41, 42, 43, 44 accumulates on each side in an accumulation device 7 so that in each accumulation device, the excess parts of both webs intersect, creating a seal in the vacuum chamber.
the turbines can be switched on to create a vacuum in the chamber and attach the skirt to the side surfaces of the plate by means of the openings 31. This vacuum may be sufficient in some cases to pick up the layer of product.
suction through the suction openings 32 can optionally be activated by activating the vacuum pump.
the support plate can also be deployed to pass under the products and further secure displacement of the objects gripped by the device 1.

1. A gripping device to be mounted to a palletising or depalletising robot for gripping a set of products arranged in the form of at least one layer on a container, said gripping device comprising a chassis to which are mounted:
a suction plate comprising side faces forming bearing surfaces and a lower face which forms a substantially horizontal plane when the gripping device is mounted to the robot, said suction plate being connected to a first pumping device and having vacuum openings and being arranged so that its lower face comes into contact with a layer of products by a displacement of the gripping device, and
a side skirt of a flexible material forming a strip surrounding said side faces of the suction plate
wherein the side skirt is configured to move from a rest position in which it is at a distance from the at least one layer of products to a working position in which it is in contact with the at least one layer of products and the bearing surfaces of the suction plate and in which the side skirt forms with the plane a closed vacuum volume above and to the sides of the at least one layer of products, the suction plate being vertically movable with respect to the side skirt to adapt the vacuum volume to the height of the at least one layer of products to be gripped by the gripping device.

2. The gripping device according to claim 1, wherein the suction plate comprises side openings on its contour for adhering the side skirt to its bearing faces by suction in the working position.

3. The gripping device according to claim 1, further comprising a clamping device which can be activated to come into contact with and/or clamp the at least one layer of products.

4. The gripping device according to claim 3, wherein the clamping device comprises four telescopic bars forming a rectangle whose surface area decreases when the clamping device is activated to come into contact with the at least one layer of products.

5. The gripping device according to claim 4, wherein the side skirt comprises four rectangular webs each being disposed on one side of the rectangle defined by the telescopic bars and having a length similar to the maximum length of the telescopic bar disposed on the same side of the rectangle and having a lower side partially attached thereto.

6. The gripping device according to claim 5, wherein an accumulation device is arranged between each pair of adjacent telescopic bars, said accumulation device being configured to receive an excess part of each of the two webs attached to said pair of telescopic bars when the clamping device is activated to contact the at least one layer of products.

7. The gripping device according to claim 1, further comprising a tray for supporting the at least one layer of products, horizontally movable between a support position in which it is located under the at least one layer of products and a retracted position in which it is away from the products.

8. The gripping device according to claim 7, wherein the support tray is formed by a plurality of panels hinged to one another and capable of being deployed under the products in the support position and of being retracted in the retracted position.

9. The gripping device according to claim 1, wherein the suction plate further comprises suction openings connected to a second pumping device and configured to suck up products when the suction plate is in a position of contact with the at least one layer of products.

10. A palletising or depalletising system, comprising a robot provided with a gripping device according to claim 1.
